(19) United States
(12) Patent Application Publication
(10) Pub. No.: US 2008/0297908 A1
(43) Pub. Date: Dec. 4, 2008

(54) OPTICAL SHEET AND DISPLAY UNIT USING THE SAME

(76) Inventors: Kei Adachi, Tokyo (JP); Koji Hirata, Yokohama (JP); Masahiko Yatsu, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/131,210

(22) Filed: Jun. 2, 2008

(30) Foreign Application Priority Data
Jun. 4, 2007 (JP) JP2007-147616

(51) Int. Cl. G02B 5/02

(52) U.S. Cl. 359/599

(57) ABSTRACT

Provided is a contrast enhancing sheet having an excellent bright room contrast function and laid on the screen of a display unit, comprising a plurality of light transmitting portions each having a trapezoid-like sectional shape in a predetermined direction, and a plurality of light absorbing portions each having a wedge-like sectional shape, the top side of the trapezoid-like sectional shape of the light transmitting portion being adjacent to the bottom side of the wedge-like sectional shape of the light absorbing portion, wherein a light diffusion means is provided at the top side of the trapezoid-like sectional shape of the light transmitting portion.

### INCORPORATION BY REFERENCE

The present application claims priority from Japanese application JP2007-147616 filed on Jun. 4, 2007, the content of which is hereby incorporated by reference into this application.

### BACKGROUND OF THE INVENTION

The present invention relates to a technology for improving a contrast function and reducing moiré in the so-called flat type display panel (a display panel of, for example, LCD (Liquid Crystal Display), PDP (Plasma Display Panel), FED (Field Emission Display)) in which pixels are arrayed in a matrix state.

A display unit using a flat type display panel is used for a television display unit (TV). Since a TV is often enjoyed in a bright environment, it is necessary to restrain lowering of the contrast of a display panel caused by the reflection of ambient light (for example, indoor lighting) upon the display panel (that is, to aim at enhancing the contrast in a bright room).

There has been known the technology for improving the contrast in a bright room by reducing the reflection of ambient light. For example, JP-A-2006-189867 discloses an optical sheet in which light transmitting portions extending transverse of a screen on a display panel, and wedge-like black stripes for absorbing ambient light are alternately arranged in the vertical direction of the screen.

Since the optical sheet having a configuration as stated above has a periodic array pattern (which will be hereinbelow referred to “original pattern”) composed of the light transmitting portions and the black strives (light absorbing portions) which are alternately arranged, ambient light transmitted through the optical sheet and irradiated upon the screen of the display panel inevitably has a pattern analogous to the above-mentioned original pattern. Thus, the ambient light reflected upon the screen of the display panel also has a pattern (which will be hereinbelow referred to as “reflection pattern”) similar to the original pattern.

The ambient light having the above-mentioned reflection pattern, which is reflected upon the display panel and is again incident upon the optical sheet, interferes with the original pattern defined by the light transmitting portions and the light absorbing portions, causing moiré (interference fringes). The moiré is superposed optically with a displayed image, possibly resulting in occurrence of visual noise.

JP-A-2006-189867 discloses a diffusion film having an antiglare surface having a fine relief structure additionally provided to the optical sheet, for scattering the ambient light having transmitted through the light transmitting portions and directed to the display panel so as to disorder the reflection pattern thereof in order to restrain the moiré.

However, the above-mentioned display panels would inevitably cause the optical sheets to increase its costs, and as a result, display units incorporating this optical sheet increase their costs.

### BRIEF SUMMARY OF THE INVENTION

The present invention is devised in view of the above-mentioned problems, and an object of the present invention is to provide an optical sheet having a convenient structure capable of restraining the moiré.

To the end, according to the present invention, there is provided an optical sheet formed therein with a plurality of light absorbing portions and a plurality of light transmitting portions, characterized in that each of the light transmitting portions is formed with a light diffusion element. This light transmitting portion has a sectional shape in a first direction, which is a trapezoid-like, the trapezoid-like sectional shape having a top side facing toward the above-mentioned screen, and a bottom side facing toward the image viewing side. Each of the plurality of light absorbing portions may have a wedge-like sectional shape in the above-mentioned first direction.

The above-mentioned light diffusion element may be a concave lens formed on the top side of the trapezoid-like sectional shape, a concave lens formed on the bottom side of the trapezoid-like sectional shape, a convex lens formed on the top side of the trapezoid-like sectional shape, or a fine irregular pattern formed on the top side of the trapezoid-like sectional shape.

According to the present invention, the moiré can be reduced by a convenient configuration. Thus, the present invention can eliminate the necessity of using a diffusion film for reducing the moiré as used in the conventional technology, thereby it is possible to restrain increasing of its cost, and to reduce the moiré.

Other objects, features and advantages of the invention will become apparent from the following description of the embodiments of the present invention taken in conjunction with the accompanying drawings.

### BRIEF DESCRIPTION OF THE SEVERAL VIEWS OF THE DRAWING

FIG. 1 is a principal part of a display unit incorporating a contrast enhancing sheet in an embodiment 1 of the present invention;

FIG. 2 is a schematic sectional view illustrating the contrast enhancing sheet in the embodiment 1;

FIG. 3 is an enlarged view illustrating an essential part of the contrast enhancing sheet in the embodiment 1;

FIG. 4 is a schematic sectional view illustrating a contrast enhancing sheet in a variant form of the embodiment 1;

FIG. 5 is a schematic sectional view illustrating a contrast enhancing sheet in a embodiment 2 of the present invention;

FIG. 6 is an enlarged view illustrating an essential part of the embodiment 2; and

FIG. 7 is an enlarged view illustrating an essential part of a contrast enhancing sheet in a third embodiment of the present invention.

### DETAILED DESCRIPTION OF THE INVENTION

Explanation will be hereinbelow made of embodiments of the present invention with reference to the accompanying drawings. It is noted that like reference numerals are hereinbelow used to denote elements having like functions throughout the drawings, and accordingly, duplication of explanation to those which has been once explained before will be omitted.

### Embodiment 1

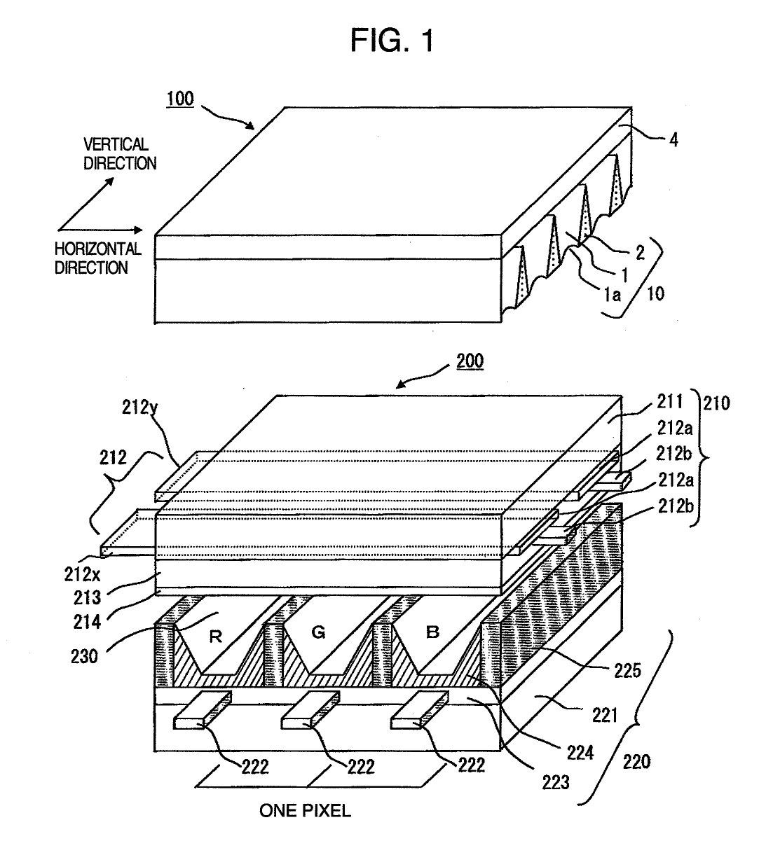

At first, with references to FIGS. 1, 2 and 3, explanation will be made of a first embodiment of the present invention.

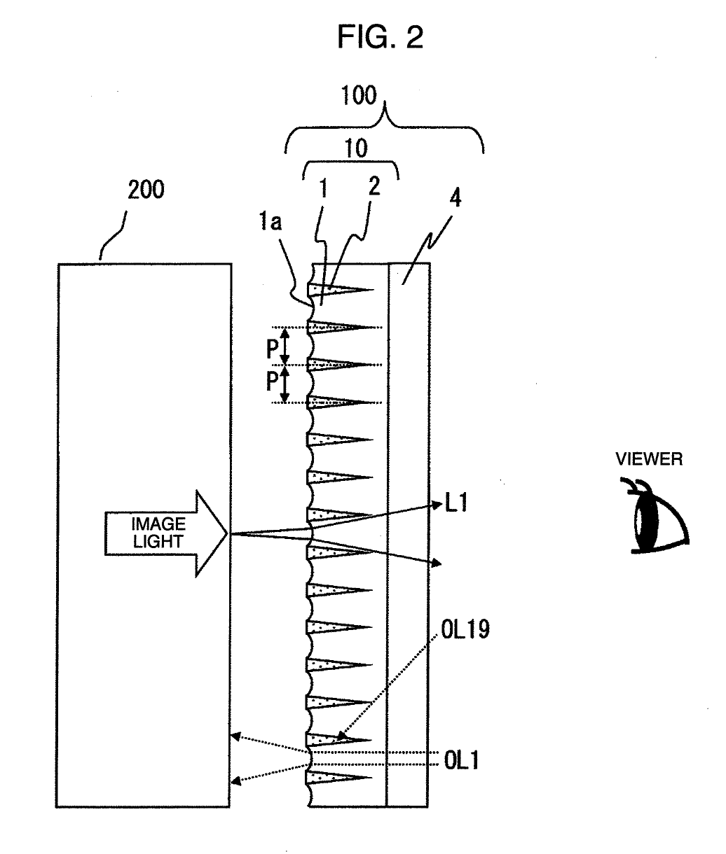

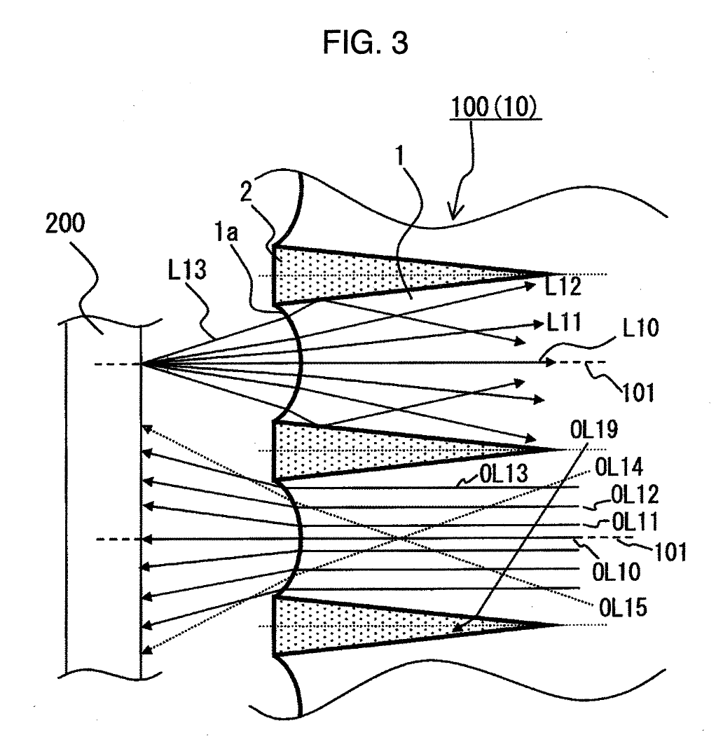

FIG. 1 is a perspective view illustrating an essential part of a display unit incorporating an optical sheet according to the present invention. It is noted that that the optical sheet in this embodiment is provided in order to enhance, in particular, the contrast of the display unit, and accordingly, this optical sheet will be hereinbelow referred to as “contrast enhancing sheet”. FIG. 2 is a schematic sectional view illustrating the contrast enhancing sheet in this embodiment, and FIG. 3 is an enlarged view illustrating the essential part of the contrast enhancing sheet shown in FIG. 3.

As to a display unit incorporating the contrast enhancing sheet in this embodiment, there may be exemplified a display unit incorporating a display panel (the so-called flat type display panel) in which pixels for displaying an image are two-dimensionally arrayed, such as a PDP display unit, an LCD display unit or an FED (Field Emission Display) display unit. In this embodiment, the present invention will be explained with the use of a PDP display unit as one of the display units for the sake of convenience. However, the present invention should not be limited to such a PDP display unit.

In FIG. 1, for ease of explanation as to the configuration of the PDP, an upper panel and a lower panel thereof are shown being separated from each other. Further, FIG. 2 shows a section of the contrast enhancing sheet which is sectioned along the vertical direction of a screen in the display unit. It is noted that the long side direction of the screen will be hereinbelow referred to as the transverse direction (which will be also referred to as “left-to-light direction” or “horizontal direction”) and the short side direction of the screen will be referred to the vertical direction (which will be also denoted as “up-and-down direction” or “perpendicular direction”).

Referring to FIG. 1, the display unit (the PDP display unit in this embodiment) is composed of a plasma display panel (PDP) 200 serving as an image light source, a contract enhancing sheet 100 arranged in front of the screen of the PDP 200, and a circuit board (which is not shown) for driving the PDP serving as a display part. The viewer who takes a position on the image viewing side enjoys an image from the PDP with a blight room contrast being enhanced by the contrast enhancing sheet 100. It is noted that the contrast enhancing sheet 100 may be attached to the screen of the PDP 200, direct thereto or may be spaced from the screen by a predetermined distance. Explanation will hereinbelow will be made of such configuration that the contrast enhancing sheet is spaced from the screen of the PDP 200 by a predetermined distance.

At first, explanation will be made of the configuration of the PDP. The PDP 200 is composed of an upper panel 210 and the lower panel 220 which are opposed to each other.

First, the configuration of the upper panel 210 will be explained. In the upper panel 210, an upper glass substrate 211 serving as a substrate on the screen side, is provided thereover with stripe-like electrodes 212 extended in the transverse direction and constituting a group in which they are arranged in pairs, in parallel with one another, and each pair being composed of an X-display electrode (which is also called as a common electrode) 212x and a Y-display electrode (which is also called as a scanning electrode) 212Y, each of the display electrode being composed of a transparent electrode 212a and an auxiliary metal electrode 212b for lowering a resistance value. It is noted here that only one pair of the display electrodes 212 (212x, 212y) is shown in this figure, for the sake of brevity in illustration. Further, a dielectric layer 213 is formed on the display electrodes 212 so as to cover the display electrodes 212, and further, a MgO protecting film 214 is formed so as to cover the dielectric layer 213.

Next, the configuration of the lower panel 220 will be explained. In the lower panel 220, parallel strip-like address electrodes 222 are formed on a lower glass substrate as a substrate on the rear surface side, being extended in the vertical direction of the screen, orthogonal to the display electrodes 212, at predetermined pitches in the transverse direction. A dielectric layer 223 is formed on the address electrodes 223 which are therefore covered therewith, and partition walls 225 are formed on the dielectric layer 223, in parallel with the address electrodes 222 at a predetermined pitches so as to interpose therebetween the address electrodes 222. Red (R), green (G) and blue (B) fluoresce substances 224 constituting pixels are coated on the dielectric layer 223 which is partitioned by the partition walls 225, corresponding to adjacent three address electrodes 222 constituting one pixel.

The upper panel 210 and the lower panel 220 which are configured as stated above are opposed to each other in such a way that the display electrodes 212 and the address electrodes 222 are extended, orthogonal to each other, and are then hermetically jointed to each other with the use of frit glass or the like which is not shown. Thus, a plurality of discharge cells (discharge spaces) 230 are defined respectively at positions where the plurality of display electrodes in the upper panel and the plurality of address electrodes in the lower panel are orthogonal to each other. The discharge cells 230 are charged therein with mixed gas such as neon (Ne) or xenon (Xe), as a discharge gas, with a predetermined pressure.

In the PDP 200 having the above-mentioned configuration, at first, the address electrodes 222 and the Y address electrodes 212y are energized by the drive circuit (which is not shown) so as to produce wall charges (this operation will be referred to as “address drive”), and then, the X-display electrodes 212x and the Y-display electrodes 212y are applied alternately therewith voltages having reverse polarities (sustaining voltage) (this operation will be referred to “main discharge drive”) so as to sustain electric discharge. Due to the electric discharge in the discharge cells 230 caused by applying the voltages to the electrodes, ultraviolet rays are generated, exciting the fluorescent substances 224 which therefore emit red, green and blue visual light lays, and accordingly, the light (image light) emerges, passing through the upper glass substrate 211 on the display electrode side.

Next, the contrast enhancing sheet 100 in this embodiment will be explained with reference to FIGS. 1 and 2.

The contrast enhancing sheet 100 blocks electromagnetic waves and infrared rays leaking from the PDP, and compensates (adjusts) colors emitted from the PDP while serves a part of the so-called optical filter (which is not shown) having a function of attenuating ambient light. That is, the optical filter includes the contrast enhancing sheet 100 and another sheet (which will be referred to as “filter sheet” for the sake of convenience). It is noted in the figures that only the contrast enhancing sheet 100 is shown for the purpose of simplifying the explanation. Further, the contrast enhancing sheet 100 may be either integrally incorporated with or separated from the optical sheet.

The contrast enhancing sheet 100 is adapted to attenuate ambient light so as to enhance the bright room contrast, and is therefore composed of a contrast enhancing layer 10 and an emergent side base layer 4 which are arranged in the mentioned order from the PDP 200 side to the image viewing side. Naturally, the filter sheet which is not shown is formed on the contrast enhancing sheet 100 (on the image viewing side). However, it is noted here that the contrast enhancing sheet may be positioned at any position in the optical filter if the effect of enhancing the contrast can be obtained thereby.

The contrast enhancing layer 10 is composed of light transmitting portions 1 and light absorbing portions 2 which are extended in the transverse direction of the screen, being arranged alternately at predetermined pitches P in the vertical direction of the screen in a periodic manner.

The light transmitting portions 1 in the contrast enhancing layer 10 are unit light guides which are made of light transmissible materials having a refractive index N1 so as to efficiently guide incident image light toward the viewer side and are partitioned from one another by the optical absorbing portions 2 in the vertical direction of the screen. In this embodiment, a plurality of light transmitting portions 1 serving as unit light guides are arranged at predetermined pitches in a first direction of the PDP 200, that is, for example, in the vertical direction of the screen (that is, in a direction in parallel with the address electrodes 222). Further, the light transmitting portions 1 are extended in a second direction orthogonal to the first direction, in a strip-like manner, for example, along the transverse direction of the screen (that is, in parallel with the display electrodes 212).

Further, each of the light transmitting portions 212 has a trapezoid-like sectional shape having a top side facing the PDP 200 side of the image light source, along the transverse direction of the screen of the PDP. That is, the top side of the trapezoid-like sectional shape faces the PDP 200 side, and the bottom side thereof faces the image viewing side. The top side of the trapezoid-like sectional shape (that is, the sectional shape of an aperture in the PDP side end part of the optical transmitting portion partitioned by the light absorbing portions 2) is formed in a concave lens-like shape having a predetermined curvature with respect to the PDP, as clearly understood from FIG. 2. That is, the concave lens which is concave toward the PDP 200 side is formed at the image light incident side of the light transmitting portion 1. The part having a concave lens-like shape at the top side of the trapezoidal shape will be hereinbelow referred to as “concave lens-like shape part 1a”. This concave lens-like shape part exhibits a diffusion lens effect since the air (having a refractive index of substantially 1) which is not shown, is present between the PDP 200 and the contrast enhancing sheet 100. That is, the concave lens-like shape part 1a serves as an diffusion lens functioning part for refracting and diffusing the transmitting light outward. That is, it may be said that the concave lend shape part 1a constitutes a light diffusing element. It is noted that diffusing effect of the concave lens-like shape part 1a will be explained later with reference to FIG. 3.

Each of the light absorbing portions 2 constitutes an ambient light shield layer for absorbing incident ambient light so as to block the same, and is made of materials having a refractive index N2 which is smaller than the refractive index of the light transmitting portion 1, and is colored with a pigment such as carbon or a predetermined stain at a predetermined concentration. These light absorbing portions 2 are formed so as to burry grooves defined between the adjacent light transmitting portions 1, having a wedge-like sectional shape with its bottom side facing the PDP side of the image light source, along the transverse direction of the screen of the PDP 200. That is, the light transmitting portions 1 and the light absorbing portions 2 are adjacent to each other in pairs, and are arrayed at predetermined pitches P, alternately and periodically in the vertical direction of the screen of the PDP. That is, one of the light transmitting portions serving as unit light guide is partitioned from adjacent light transmitting portions through the intermediary of the light absorbing portions 2. It is noted that the section along the transverse direction of the screen will be simply referred to as “section”.

By the way, the light transmitting portions 1 and the light absorbing portions 2 are periodically arranged at the pitches P, and accordingly, there would be possibly caused such a risk that interference occurs between this periodical pattern (original pattern) and the pixel array pattern of the PDP. Thus, in order to reduce the interference, more than one of the light transmitting portions 10 which are partitioned by the light absorbing portions 2 are arranged within the range of a single discharge cell in the PDP. In general, not less than 5 of the light transmitting portions 1 are arranged per discharge cell. Further, the pitches P may be in general set to be in a range from 70 to 100 μm as disclosed in the Patent Document 1 (JP-A-2006-189867)

The emergent side base layer 4 is an optical support for supporting the contrast enhancing layer 10, and further, in such a case that the contrast enhancing sheet 100 is integrally incorporated with the optical filter, it serves as a coupling layer. The emergent side base layer 4 is formed of the same light transmissible material as that of the light transmitting portions 1, and accordingly, has a refractive index N1.

In this embodiment, the refractive index N1 of the light transmitting portions 1 and the refractive index N2 of the light absorbing portions 2 (N1>N2) are set so as to have a predetermined refractive index ratio (or a predetermined refractive index difference) in a predetermined range in which ambient light is absorbed in the light absorbing portions 2 and image light incident thereupon from the PDP is efficiently transmitted through the light transmitting portions and is then led to the viewer side, as, for example, disclosed in the Patent Document 1. That is, the refractive indices N1, N2 are set to predetermined values so that a critical angle with which the boundary between the light transmitting portion 1 and the light absorbing portion 2 causes total reflection becomes larger.

The ambient light (indicated by reference mark OL in the figure) from indoor lighting (for example, fluorescent lumps) or the like is incident upon the contrast enhancing sheet 100, oblique thereto, and accordingly, it is incident upon any of the light absorbing portion 2 (as indicated by light rays OL19). At this stage, since the incident angle (angle making with respect to the line normal to the inclined surface of the light absorbing portion 2) is small, the ambient light enters into the light absorbing portion 2 so as to be absorbed thereby.

Meanwhile, the light rays L1 of image light emitted from the PDP 200 are incident upon the light transmitting portions 1 of the contrast enhancing layer 1, then are diffused by the concave lens-like shape parts 1a, as will be detailed later, and directed forward so as to finally emerge after being reflected upon boundaries between the light transmitting portion 1 and the light absorbing portion 2 (as will be detailed later).

Since the contrast enhancing sheet 100 is configured as stated above, the viewing angle characteristic in the vertical direction of the screen is set to a predetermined characteristic while a satisfactory viewing angle characteristic in the vertical direction of the screen is ensured, and accordingly, the ambient light is absorbed, thereby it is possible to enhance the bright room contrast.

By the way, the ambient light has not only light components which are obliquely incident upon the contrast enhancing sheet 100, but also light components (indicated by light rays OL1 in FIG. 2) which are incident upon the contrast enhancing sheet, substantially in parallel with the line normal to the contrast enhancing sheet 100, that is light components which emitted from fluorescent lamps attached to the ceiling of a room and are reflected upon the walls of the room. The above-mentioned ambient light enters into the light transmitting portions 1, passing therethrough (or being totally reflected upon the light absorbing portions 2 although not shown), and is led to the PDP. The ambient light (which is not shown) reflected upon the PDP (for example, reflected upon the fluorescent substances 224) has a reflection pattern analogous to the vertical periodical pattern (original pattern) of the contrast enhancing layer 10. Thus, when the ambient light reflected upon the PDP 200 is again incident upon the light transmitting portions 1, it interferes with the original pattern of the contrast enhancing layer 10 so as to cause moiré. Thus, in order to reduce the moiré in this embodiment, concave lens-like shape parts 1a serving as light diffusing elements are formed in the apertures of the PDP side end parts (the top side of the trapezoid-like sectional shape) of the light transmitting portions.

An example of a method of forming the above-mentioned contrast enhancing sheet 100 will be explained below. At first, the emergent side base layer 4 serving as a support is coated over its one surface with a base material composed of ultraviolet ray hardenable resin and forming the light transmitting portions 1. Next, the thus coated emergent side base member 4 is led and pinched between wedge-like shape forming rolls (which are not shown) formed on its outer surface with wedge-like cross-sectional shapes and sectional shapes reverse to concave lens-like shapes. Thus, wedge-like grooves are transferred onto the emergent side base layer 4 (concave lens-like shapes are formed between the grooves). Ultraviolet rays are irradiated to the grooves so as to harden the base material in order to form the light transmitting portions 1 incorporating the concave lens-like shape parts 1a. Thereafter, ultraviolet hardenable resin which has been colored by carbon or the like up to a predetermined concentration, is filled in the grooves, and is then irradiated thereto with ultraviolet rays in order to form the wedge-like light absorbing portions 2. Thus, in this embodiment, the concave lens-like shape parts 1a serving as light diffusing elements (diffusing lens effecting parts in this embodiment) can be integrally formed, simultaneously with the formation of the light transmitting portions, thereby it is possible to reduce the moiré at low costs.

Next, referring to FIG. 3, explanation will be made of the diffusion effect of the concave lens-like shape parts in this embodiment. FIG. 3 is an enlarged view which illustrates an essential part of the contrast enhancing layer shown in the sectional view of FIG. 2, and which also show right lays exhibiting the diffusion effect of the concave lens-like shape part in this embodiment. For the sake of readily understanding the configuration, FIG. 3 schematically shows the configuration without being dimensional. It is noted that the emergent side base layer 4 is not shown for the sake of brevity as to illustration.

At first, light rays from the image light which has been incident upon the contrast enhancing sheet 100 from the PDP 200 will be explained, and then, light rays from ambient light which has been incident upon the contrast enhancing sheet 100 will be explained. It is noted that numerals attached thereto with the letter “L” denote light lays relating to the image light, and numerals attached thereto with the letters “OL” denote light rays relating to the ambient light so as to avoid confusion.

As shown in FIG. 3, in this embodiment, the light transmitting portion 1 between two adjacent light absorbing portions 2 is symmetric in the section in the vertical direction. Thus, the symmetric axis of the light transmitting portion 2 (which will be referred to as “optical axis”) will be denoted by reference numeral 101.

The light rays emerged from the PDP 200 is not parallel, having a Lambert distribution with a substantially uniform light quantity distribution (light emission pattern). That is, as shown in FIG. 3, the light rays are radially emerged from the PDP 200 as shown in FIG. 3. Of the image light which has been incident upon the contrast enhancing sheet 100, the light ray L10 on the optical axis 101 of the light transmitting portion 1 is not refracted by the concave lens-like shape part 1a, then goes straightforward as it is, and finally emerges from the contrast enhancing sheet 100. Of the light rays which has been incident upon, being obliquely with respect to the optical axis 101, the light lays L11, L12 having an oblique angle with respect to the optical axis 101 are refracted by the concave lens-like shape part 1a so as to be diverged (broadened) thereat, that is, they are diffused, being away from the optical axis 101 before they emerge. The light lay L13 having a large oblique angle with respect to the optical axis 101 is refracted by the concave lens-like shape part 1a, then is totally reflected at the boundary between the light transmitting portion 1 and the light absorbing portion 2, and thereafter emerges being parallel with or oblique to the optical axis 101.

Thus, the light transmitting portion 1 in the contrast enhancing layer 10 refracts the image light incident upon the concave lens-like shape part 1a, then causing it to go straightforward or reflect at the boundary between the light transmitting portion 2 and the light absorbing portion 2, and allows the image light to emerge toward the viewer side, and accordingly, the incident image light can be efficiently led to the viewer side. Further, since light lays having various emergent angles with respect to the optical axis 101 in the vertical direction of the screen emerge from the light transmitting portion 1, the viewing angle characteristic in the vertical direction of the screen can be desirably set.

Next, the diffusion of ambient light by the concave lens-like shape part 1a will be explained.

The light lay OL19 of the ambient light from, for example indoor lighting (for example, fluorescent lamps), which is incident upon the contrast enhancing sheet 100 from a position obliquely thereabove enters into the light absorbing portion 2 with a small incident angle (angle with respect to the line normal to the oblique surface of the light absorbing portion 2). The refractive index N2 of the light absorbing portion 2 is smaller than the refractive index N1 of the light transmitting portion 1, and is set so that the refractive index ratio (N1/N2) has a value nearly equal to 1 so as to cause the difference (N1−N2) between the refractive indices to become small. That is, the refractive indices N1, N2 are set respectively to predetermined values so that the critical angle with which a light ray is totally reflected at the boundary between the light transmitting portion 1 and the light absorbing portion 2 becomes larger. Accordingly, the light ray OL19 from the ambient light is not totally reflected, but is led into the light absorbing portion 2 so as to be absorbed thereby. Since the image light is efficiently transmitted but the ambient light is absorbed, it is possible to enhance the bright room contrast.

However, of ambient light emitted from indoor lighting and reflected upon, for example, a wall of a room, light rays which are incident upon the contrast enhancing sheet 100, substantially perpendicular thereto are present, that is, light rays which are incident thereupon, substantially parallel with the optical axis 101, or with small oblique angles thereto are present. When such ambient light is incident upon the contrast enhancing layer 10, the light rays OL11, OL12, OL13 which are off-axis and which are parallel with the optical axis 101 are refracted by the concave lens part 1a so as to be away from the optical axis 101 (being diverged), that is, they are refracted so as to be diffused by the concave lens-like shape part 1a, except the light ray OL10 on the optical axis 101. The light rays OL14, OL15 having small oblique angles with respect to the optical axis 101 are similarly diffused by the concave lens-like shape part 1a.

Thus, the ambient light which is incident upon the contrast enhancing layer 10 in parallel with the optical axis or at a small oblique angle to the optical axis is diffused by the concave lens-like shape part 1a formed at the end of the light transmitting portion 1. The ambient light which has transmitted through the contrast enhancing sheet 100 is reflected upon the PDP 200. Unless the ambient light is diffused by the concave lens-like shape part 1a, a secondary light source image (which is not shown) having the periodic array pattern (original pattern) of the light transmitting portions 1 and the light absorbing portions 2 in the contrast enhancing layer 10 would be created. This secondary light source image would have a reflection pattern analogous to the original pattern, and accordingly, would causes interference with the original pattern so as to generate interference fringes (moiré) when the light again is transmitted through the contrast enhancing sheet 100.

However, in this embodiment, the ambient light is diffused by the concave lens-like shape part 1a serving as a light diffusion element. Due to such diffusion, the secondary light source image having the original pattern formed on the reflection surface (for example, the fluorescent substance) of the PDP is enlarged so as to become larger than the original pattern, and is overlapped with the adjacent pattern, and accordingly, the secondary light source image is turned into a substantially flat surface. Thus, even though the reflection light is transmitted through the contrast enhancing layer 10, the reflection pattern and the original pattern can hardly interfere with each other, and accordingly, the moiré is greatly reduced, which is visually negligible.

As stated above, according to this embodiment, it is possible to eliminate the necessity of provision of a diffusion film exclusively used for reducing moiré as conventionally required, it is possible to reduce the moiré with the use of the concave lens-like shape part 1a serving as an optical diffusion element (diffusion effecting part in this embodiment) which is integrally incorporated with the light transmitting portion 1, without greatly increasing the costs.

Naturally, in the case of adding the emergent side base layer for the purpose of protecting the outer surface of the contrast enhancing layer 10 on the PDP 200 side, the refractive index of a member adapted to make contact with the contrast enhancing layer is required to be set to a predetermined value which is small than the refractive index N1 of the light transmitting portion 1.

Although explanation has been made such that the sectional shape of the light absorbing portion has a wedge-like shape which is substantially triangular, the present invention should not be limited thereto. For example, as disclosed in JP-A-2005-338270 (refer to FIG. 8(c)), there may be used a light absorbing portion composed of two wedge-like parts having different inclinations or a plurality of wedge-like parts. Further, as also disclosed in this document (refer to FIG. 8(b)), there may be used a light absorbing portion having inclinations in cross-section defined by smooth curves. It goes without saying that the sectional shape of the light absorbing portion may be quadrangular, having parallel side surfaces, instead of the inclined side surfaces of the wedge-like light absorbing portion, as in a contrast enhancing sheet disclosed in JP-A-2004-12918 (refer to FIG. 16, disclosing a louver sheet as the contrast enhancing sheet). In this case, the light transmitting portion has also a quadrangular sectional shape, rather than a trapezoidal-like sectional shape.

Further, although explanation has been hereinabove made such that the contrast enhancing sheet is spaced from the PDP by a predetermined distance, the present invention should not be limited thereto. The contrast enhancing sheet may be joined to the PDP through the intermediary of an adhesive layer formed on the PDP side of the contrast enhancing sheet. In this case, it goes without saying that the refractive index of the adhesive layer is set to a value which is smaller than the refractive index N1 of the light transmitting portion in order to enable the concave lens-like shape part 1a at the PDP side end (aperture) of the light transmitting portion 1 to serve has a light diffusion element having a diffusion lens function.

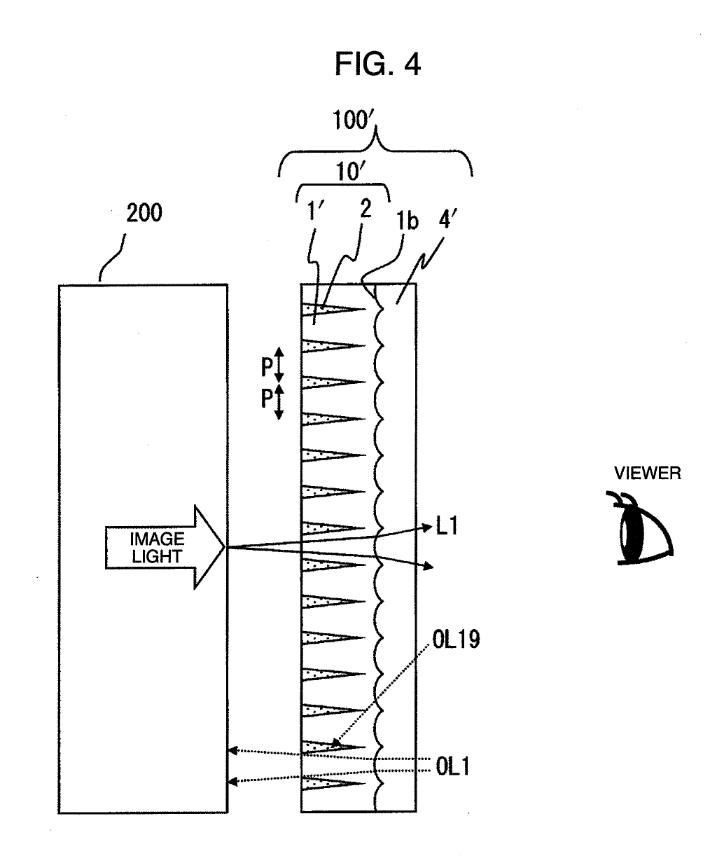

Further, although explanation has been hereinabove made such that the diffusion lens function part serving as the light diffusion element is formed in the aperture at the PDP side end of the light transmitting portion 1, the present invention should not be limited thereto. For example, as shown in FIG. 4, a concave lens-like shape part b which is concaved toward the image viewing side may be formed in the aperture on the image viewing side of a light transmitting portion 1′ of a contrast enhancing layer 10′, that is, on the image light emerging side of the light transmitting portion 1′. It is noted that the refractive index N4 of an emergent side base layer 4′ is set to be a predetermined value which is smaller than the refractive index N1 of the light transmitting portion 1′.

It is noted that in order to enable the interface shape between the light transmitting portion 1′ and the emergent side base layer 4′ having an interface with respect to the former, to have a diffusion lens function, there may be used another method different from the method as stated above. For example, the interface shape may be set so as to be convex toward the viewer side, and the refractive index N4 of the emergent side base layer 4′ is set to a predetermined value which is larger than the refractive index N1 of the light transmitting portion 1′. Even in this configuration, there may be materialize a diffusion lens function.

By the way, in this embodiment, although the explanation has been made, in this embodiment, of the contrast enhancing sheet composed of the light transmitting portions each serving as unit light guide member and each having a trapezoid-like sectional shape with its top side facing toward the display panel (the PDP in the above-mentioned example), as an example of the contrast enhancing sheet according to the present invention, as disclosed, for example, in the patent document 1, the present invention should not be limited thereto. For example, the present invention can be applied to a contrast enhancing sheet in which the top side of each trapezoid-like shape light transmitting portion faces toward the image viewing side, as disclosed in JP-A-2003-50307. Even in this case, the sectional shape of the aperture at the image light source side end of the light transmitting portion serving as a unit light guide member is, for example, concave lens-like so as to serve as a diffusion lens part, and accordingly, the ambient light transmitted through the contrast enhancing sheet, is diffused, thereby it is possible to reduce the moiré. This embodiment may have, for example, such a configuration that the image viewing side of the contrast enhancing sheet shown in FIG. 4 is used as the image light source side while the image light source side thereof is used as the image viewing side.

### Embodiment 2

Explanation has been made of the embodiment 1 in which the sectional shape of the PDP side end part of the light transmitting portion 1 is concave lens-like with respect to the PDP so as to have a diffusion lens function at the interface with respect to the air layer, having a function of a light diffusion element (diffusion lens effect part).

On the contrary, in the embodiment 2, the sectional shape of the PDP side end part of a light transmitting portion 1 is set to be convex lens-like so as to form a light diffusion element which is convex toward the PDP. The thus formed convex lens can have a light converging function at the interface thereof with respect to the air layer in order to diffuse the light.

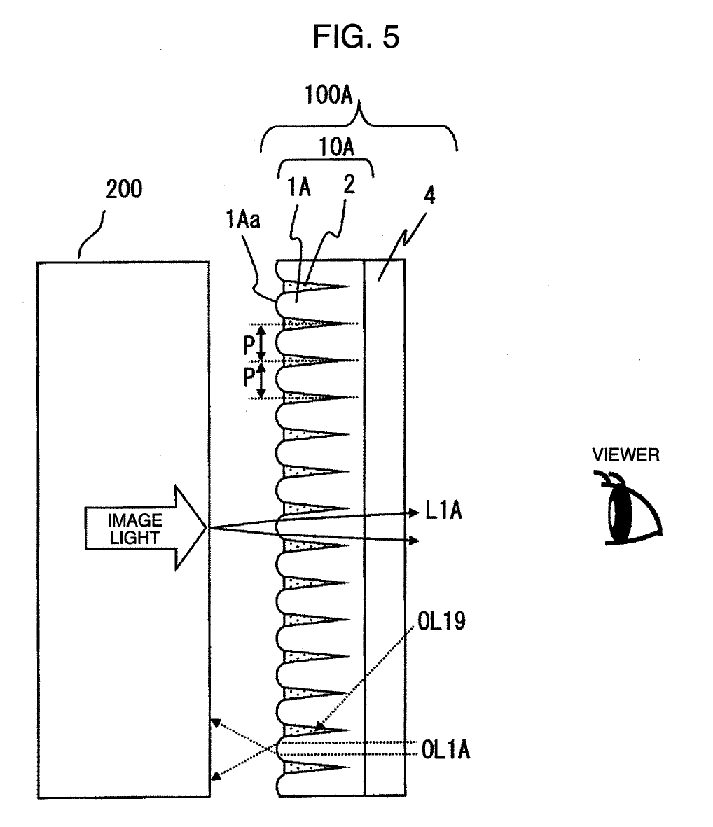

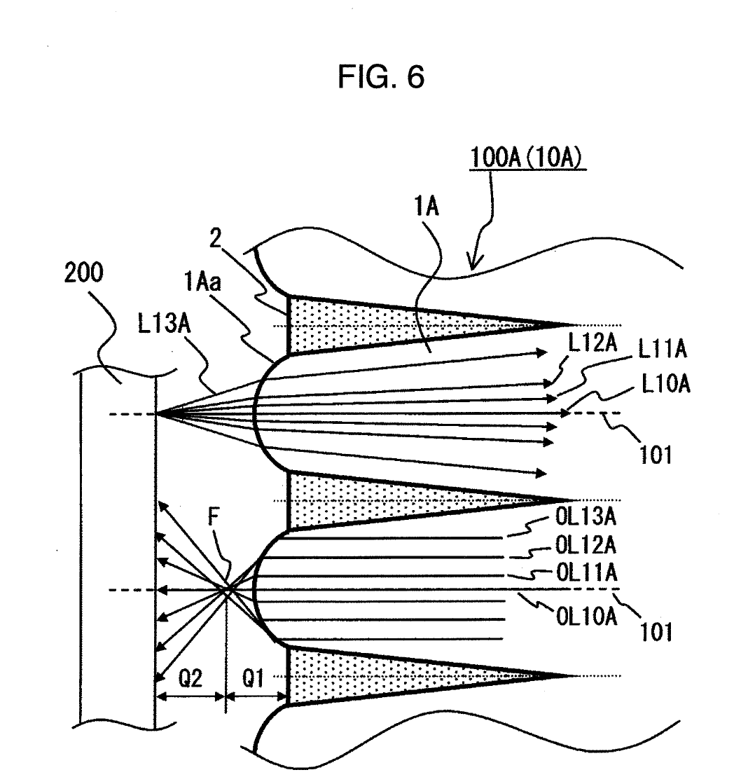

FIG. 5 is a schematic sectional view which shows a contrast enhancing sheet in this embodiment, and FIG. 6 is an enlarged view illustrating an essential part of the contrast enhancing sheet in this embodiment.

As shown in FIG. 5, the contrast enhancing sheet 100A in this embodiment is composed of a contrast enhancing layer 10a, and an emergent side base layer 4 which are arranged in the mentioned order from the PDP 200 side, similar to the embodiment 1.

Similar to the embodiment 1, the contrast enhancing layer 10A includes light transmitting portions 1A made of a light transmissible material having a refractive index N1, and light absorbing portions 2 for absolving incident ambient light so as to block it, the light transmitting portions 1A and the light absorbing portions 2A being extended in the transverse direction of the screen and are alternately arrayed, periodically at predetermined pitches P in the vertical direction of the screen. The configuration of this embodiment is the same as that of the embodiment 1, except that the PDP side end part of each light transmitting portion 10A in the contrast enhancing layer 10A, on the image light incident side is formed in a convex lens-like shape, instead of the concave lens-like shape. Accordingly, a concave lens-like shape part 1Aa is formed in the aperture of the PDP side end part of the light transmitting portion 1A. The convex lens-like shape part 1Aa faces an air layer which is not shown, and accordingly, serves as a light converging lens function part.

Next, referring to FIG. 6, explanation will be made of the diffusion effect of the convex-like lens-like shape parts 1Aa in this embodiment. FIG. 6 is an enlarged view which illustrates the configuration of an essential part of the contrast enhancing layer 10A shown in the sectional view of FIG. 5, and which also shows light rays for exhibiting the diffusion effect of the convex lens-like shape parts. FIG. 6 is schematic, and is not dimensional in order to easily understand the configuration. Further, the emergent side base layer 4 is not shown for the sake of brevity for illustration.

At first, light rays of image light incident upon the contrast enhancing sheet 100A from the PDP 200 will be explained, and thereafter, light rays of ambient light incident upon the contrast enhancing sheet 100A will be explained.

As shown in FIG. 6, of the image light which has been incident upon the contrast enhancing sheet 110A from the PDP 200, a light ray L10A on the optical axis 101 of the light transmitting portion 1A is not refracted by the convex lens-like shape part 1Aa, then goes straightforward as it is, and emerges from the contrast enhancing sheet 10A. Light rays L11A, L12A, L13A which have been incident upon the contrast enhancing sheet 10A, oblique to the optical axis 101, are refracted by the convex lens-like shape part 1Aa of the light transmitting portion 1A so as to be converged in order to decrease their oblique angles with respect to the optical axis 101, and thereafter, they emerge. Thus, the light transmitting portions 1Aa in the contrast enhancing layer 10 converge the incident image light more or less, and allow the light to emerge therefrom toward the image viewing side, and accordingly, the light can be efficiently guided. It is noted in this embodiment that that the viewing angle characteristic in the vertical direction of the screen is lowered more or less in comparison with that of the embodiment 1 since the light is converged. However, the value which is necessary, in use, for the viewing angle characteristic in the vertical direction of the screen is small, and accordingly, it is practically usable.

Next, explanation will be made of the diffusion of ambient light by the convex lens-like shape part 1Aa when the ambient light incident upon the contrast enhancing sheet 100A, substantially perpendicular thereto (that is, it is incident upon the contrast enhancing layer 10, substantially in parallel or with a small oblique angle to the optical axis of the light transmitting portion 10).

An air layer is present between the PDP 200 and the light transmitting portion 1A. Accordingly, the convex lens-like shape part 1Aa serves as a convex lens as to the ambient light OL which has been transmitted through the light transmitting portion 1A so as to converge the light. At this time, the ambient light which is focused (at a focal point F) in the vicinity of the convex lens-like shape part 1Aa by setting the refractive index N1 of the light transmitting portion 1A to a predetermined value while the convex-like shape is set to a specific characteristic value (for example, a specific curvature), is then incident upon the PDP 200 after being diverged (diffused). Further, for example, if the ratio between a distance Q1 from the convex lens-like shape part to the focal point F and a distance Q2 from the focal point F to a reflection surface in the PDP 200, is set to a value which is not less than, for example, 1:2, the moiré can be reduced. Thus, the convex lens-like shape part 1Aa in this embodiment is configured such that the ambient light which has been incident thereupon from the image viewing side is converged between the outer surface of the PDP 200 and the convex lens-like part 1Aa.

When the ambient light which is substantially parallel with the optical axis 101 is incident upon the convex lens-like shape part 1Aa which is configured as stated above, light rays OL11, OL12, OL13 which are off-axis are converged by the convex lens-like shape part 1Aa in the vicinity of the latter, and are thereafter diffused before they incident upon the PDP, except the light lay OL10A on the optical axis 101. The ambient light which has been incident thereupon, oblique to the optical axis 101, and which is not shown, is also converged and diffused in a similar way.

Thus, the ambient light which has been incident upon the contrast enhancing layer 10, substantially parallel with the optical axis or with a small oblique angle thereto, is converged by the convex lens-like shape part 1Aa formed at the end of the light transmitting portion 1A and thereafter diffused. The ambient light having transmitted through the contrast enhancing sheet 100A is reflected upon the PDP 200. At this time, a secondary light source image (which is not shown) in which the periodic array pattern (original pattern) of the light transmitting portions 1A and the light absorbing portions 2 is enlarged is produced in the reflection surface. This secondary light source image is largely enlarged in comparison with the original pattern, and accordingly, can hardly cause interference with the original pattern even though its reflection light passes again through the contrast enhancing layer 10A, thereby the moiré can be greatly reduced and visually neglected.

It is noted that explanation has been made of the contrast enhancing sheet which is spaced from the PDP by a predetermined distance as stated above, the present invention should not be limited thereto. The contrast enhancing sheet may be joined to the PDP through the intermediary of an adhesive layer formed on the PDP side of the contrast enhancing sheet. In this case, it goes without saying that the refractive index of the adhesive layer is set to a predetermined value which is smaller than the refractive index N1 of the light transmitting portion 1A.

By the way, if the refractive index of the adhesive layer is set to be larger than the refractive index N1 of the light transmitting portion 1A, the convex lens-like shape part 1Aa at the PDP side end of the light transmitting portion 1A exhibits a concave lens function. That is, in this embodiment 2, if the refractive index of the adhesive layer is set to be greater than the refractive index N1 of the light transmitting portion 1A, the convex lens-like shape 1Aa serves as the diffusion lens function part in the embodiment 1.

On the contrary, there may be considered as follows: if the refractive index of the adhesive layer for joining the contrast enhancing sheet to the PDP is set to be larger than the refractive index N1 of the light transmitting portion 1 in the embodiment 1, the concave lens-like shape part 1a in the embodiment 1 serves as the light converging lens part in the embodiment 2.

### Embodiment 3

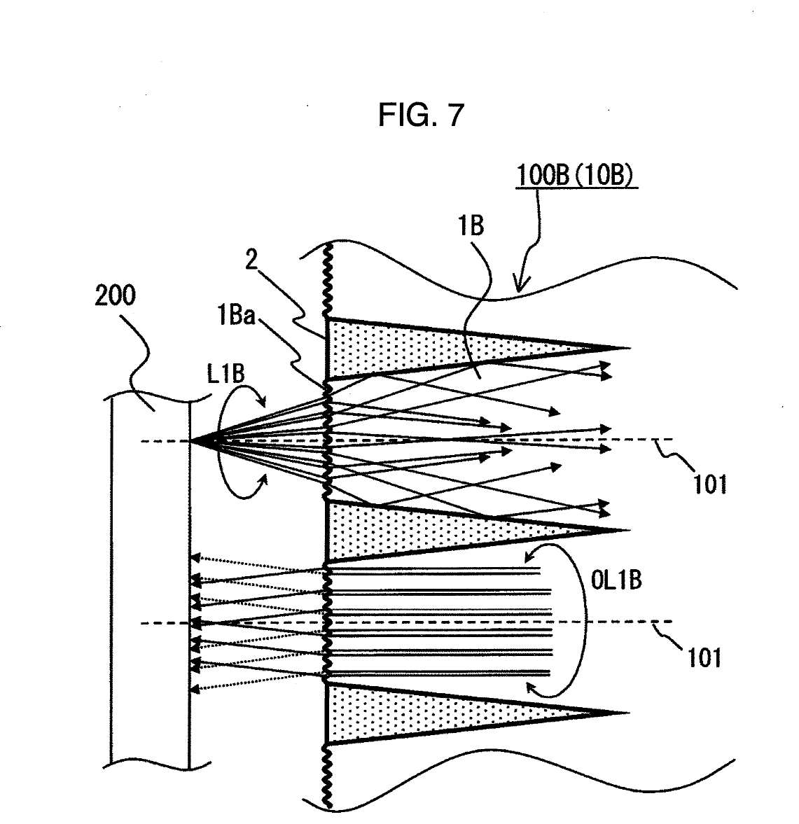

Referring to FIG. 7, explanation will be made of an embodiment 3 in which a scattering part 1Ba having a light scattering pattern is formed as a light diffusion element at the PDP side end of the light transmitting portion, instead of the concave lens-like shape part in the embodiment 1, or instead of the convex lens-like shape part in the embodiment 2.

FIG. 7 is an enlarge view which shows an essential part of the contrast enhancing sheet in this embodiment. It is noted in this figure that the emergent side base layer 4 is not shown for the sake of brevity for illustration.

As clearly understood from FIG. 7, the contrast enhancing sheet 100B in this embodiment is composed of a contrast enhancing layer 10B and an emergent side base layer 4 in the mentioned order from the PDP 200 side, similar to the embodiment 1 or 2. The contrast enhancing layer 10B are composed of light transmitting portions 1B made of a light transmissible material having a refractive index N1, and light absorbing portions 2 for absorbing and blocking ambient light which has been incident upon the contrast enhancing layer. The configuration of this embodiment is similar to those of the embodiments 1 and 2, except that the scattering part 1Ba is formed at the PDP side end of each of the light transmitting portions, instead of the concave lens-like shape part or the convex lens-like shape part.

The scattering part 1Ba is formed therein with, for example, fine irregularity having an irregular pattern (that is, a random array pattern). This scattering part 1Ba is formed by using, for example, wedge-like shape forming rolls. These wedge-like shape forming rolls have a sectional shape corresponding to wedge-like shapes of the light absorbing portions 2, for forming the wedge-like shape light absorbing portions 2 in the contrast enhancing sheet 100B, the configuration of fine irregularity being formed in the outer surfaces of flat parts between the wedges. Thus, the above-mentioned light scattering parts can be formed when the trapezoid-like light transmitting portions are formed, integral with the trapezoid-like light transmitting portions.

It is noted that the scattering part in this embodiment should not be limited to the one which is formed with the fine irregularity having an irregular pattern. For example, fine quadrangular pyramids or corns which are arrayed in a specific pattern may be used. That is, there may be used any of various kinds which can scatter light to be transmitted.

As clearly understood from FIG. 7, light rays L1B of image light from the PDP 200, which has been incident upon the light transmitting portion 1B, are scattered by the light scattering part 1Ba having fine irregularity so as to be turned into light rays having various oblique angles with respect to the optical axis 101, before it emerges toward the viewer side. Thus, the image light can have a satisfactory viewing angle characteristic.

Meanwhile, should the image light be scattered, there would be caused such a risk that the image is blurred. However, as stated in the above-mentioned embodiment 1, a plurality of light transmitting portions 1 are arranged being partitioned by the light absorbing portions 2 within a region of a single discharge cell in the PDP. Thus, the quantity of the scattered image light which leaks into regions corresponding to discharge cells adjacent thereto is less, that is, it is practically negligible. Further, by setting the distance between the PDP 200 and the contrast enhancing sheet 100b to a predetermined value, the image light can be restrained from being scattered, thereby it is possible to appropriately restrain the image from being blurred.

Further, it goes without saying that the scattering part 1Bs whose configuration is appropriately designed can suitably restrain the image from being blurred.

Next, explanation will be made of the diffusion exhibited by the scattering part 1Ba with respect to ambient light OL which is incident upon the contrast enhancing sheet 100B, substantially perpendicular thereto (that is, ambient light which is incident upon the contrast enhancing layer 10B, substantially parallel with the optical axis or with a small angel thereto).

Ambient light OL1B which is incident upon the scattering part 1Ba, substantially parallel with the optical axis 101, is scattered by the scattering part 1Ba as shown in FIG. 7. The thus scattered light is reflected upon the reflection surface of the PDP so as to create a secondary light source image having a periodic array pattern (original pattern) of the light transmitting portions 1B and the light absorbing portions 2. However, since the light is scatted by the scattering part 1Ba, this secondary light source image is blurred. Thus, even though the reflection light passes again through the contrast enhancing layer 10B, the reflection light can hardly interfere with the original pattern, and accordingly, the moiré can be greatly reduced, and visually neglected.

As stated above, even in this embodiment, the moiré can be reduced by the scattering part formed in the aperture at the end of the light transmitting portion. The scattering part may be integrally incorporated with the aperture at the end of the light transmitting portion, and accordingly, the necessity of using a scattering film which has been conventionally used exclusively for reducing the moiré can be eliminated, thereby it is possible to prevent the costs from being greatly increased.

It should be further understood by those skilled in the art that although the foregoing description has been made on the embodiments of the invention, the invention is not limited thereto and various changes and modifications may be made without departing from the sprit of the invention and the scope of the appended claims.

1. An optical sheet arranged on the screen of a display unit, comprising:
a plurality of light transmitting portions arrayed at predetermined pitches in a first direction, for transmitting image light from the display unit,
a plurality of light absorbing portions arranged between the plurality of light transmitting portions, and
a light diffusing element formed in each of the light transmitting portions.

2. The optical sheet according to claim 1, wherein the light diffusing element is a concave lens which is formed on the image light incident side of the light transmitting portion and which is concave toward the screen.

3. The optical sheet according to claim 1, wherein the light diffusion element is a concave lens which is provided on the image light emergent side of the display unit and which is concave toward the image viewing side.

4. The optical sheet according to claim 1, the light diffusion element is a convex lens provided on the image light emergent side of the light transmitting portion and which is convex toward the image viewing side.

5. The optical sheet according to claim 4, wherein the convex lens is adapted to converge ambient light which has been incident upon the optical sheet from the image viewing side, between the screen and the convex lens.

6. The optical sheet according to claim 1, wherein the light diffusion element is a light scattering pattern provide on the image light incident side of the light transmitting portion.

7. The optical sheet according to claim 1, wherein each of the plurality of light transmitting portions has a trapezoid-like sectional shape in the first direction, the top side of the trapezoid-like sectional shape facing toward the screen side while the bottom side thereof faces the image viewing side, and each of the plurality of light absorbing portions has a wedge-like sectional shape in the first direction, and the top side of the trapezoid-like sectional shape of the light transmitting portion is adjacent to the bottom side of the wedge-like sectional shape of the light absorbing portion in a second direction orthogonal to the first direction.

8. The optical sheet according to claim 7, wherein the top side of the trapezoid-like sectional shape of the light transmitting portion has a concave lens-like shape with which the light diffusion element is constituted.

9. The optical sheet according to claim 7, wherein the bottom side of the trapezoid-like shape of the light transmitting portion has a concave lens-like shape with which the light diffusion element is constituted.

10. The optical sheet according to claim 7, wherein the top side of the trapezoid-like shape of the light transmitting portion has a convex lens-like shape with which the light diffusion element is constituted.

11. The optical sheet according to claim 7, wherein the top side of the trapezoid-like sectional shape of the light transmitting portion is formed with a light scattering pattern with which the light diffusion element is constituted.

12. The optical sheet according to claim 11, wherein the scattering pattern is fine irregularity.

13. The optical sheet according to claim 7, wherein the light transmitting portions and the light absorbing portions are extended in the second direction.

14. The optical sheet according to claim 7, wherein the first direction is a vertical direction of the screen, and the second direction is the horizontal direction of the screen.

15. A display unit comprising:
a display panel having a screen;
an optical sheet laid on the screen of the display panel, the optical sheet comprising a plurality of light transmitting portions arranged in predetermined pitches in a first direction, for transmitting image light from the display unit toward the image viewing side, and a plurality of light absorbing portions arrange between the light transmitting portions; and
a light diffusion element formed in each of the light transmitting portions.

16. The display unit according to claim 15, wherein each of the plurality of light transmitting portions has a trapezoid-like sectional shape in the first direction, the top side of the trapezoid-like sectional shape facing toward the screen while the bottom side therefore facing toward the image viewing side, each of the light absorbing portions has a wedge-like sectional shape in the first direction, and the top side of the trapezoid-like sectional shape of the light transmitting portion is adjacent to the bottom side of the wedge-like sectional shape of the light absorbing portion on the image light incident side in a direction orthogonal to the first direction.

17. The display unit according to claim 16, wherein the top side of the trapezoid-like sectional shape of the light transmitting portion has a concave lens-like shape with which the light diffusion element is constituted.

18. The display unit according to claim 16, wherein the bottom side of the trapezoid-like sectional shape has a concave lens-like shape with which the light diffusion element is constituted.

19. The display unit according to claim 16, wherein the top side of the trapezoid-like sectional shape of the light transmitting portion has a convex lens-like shape with which the light diffusion element is constituted.

20. The display unit according to claim 16, wherein the top side of the trapezoid-like sectional shape of the light transmitting portion is formed with a light scattering pattern with which the light diffusion element is constituted.
